(19) United States
(12) Patent Application Publication
(10) Pub. No.: US 2012/0287215 A1
(43) Pub. Date: Nov. 15, 2012

(54) REFLECTOR STRUCTURE FOR A RADIANT DRYER UNIT OF AN INKJET PRINTER

(76) Inventors: Stuart J. Boland, Denver, CO (US); Scott Johnson, Erie, CO (US); Zhenbi Su, Spring, TX (US); Casey E. Walker, Boulder, CO (US)

(21) Appl. No.: 13/468,190

(22) Filed: May 10, 2012

Related U.S. Application Data
(60) Provisional application No. 61/485,051, filed on May 11, 2011.

(51) Int. Cl. B41J 2/01; G02B 7/182

(52) U.S. Cl. 347/102; 359/871

(57) ABSTRACT

Structures for radiant dryer units of a printer. A radiant dryer unit includes a reflector element that reflects light waves from a light source back towards a printable medium to dry ink printed on the medium. The reflector element includes a plurality of modular sections. Each modular section includes a base portion having a reflective surface, and includes legs that protrude from an opposing surface of the base portion. The modular sections are affixed to one another so that the reflective surfaces of the modular sections form an aggregate reflective surface that faces toward the light source of the radiant dryer unit.

### RELATED APPLICATIONS

This non-provisional patent application claims priority to U.S. Provisional Patent Application No. 61/485,051 filed on May 11, 2011, which is incorporated by reference as if fully included herein.

### FIELD OF THE INVENTION

The invention relates to the field of production printing systems.

### BACKGROUND

Businesses or other entities having a need for volume printing typically purchase a production printing system. A production printing system comprises a high-speed printer used for volume printing, such as 100 pages per minute or more. The production printing systems are typically continuous-forms printers that print on paper or some other printable medium that is stored on large rolls. Some continuous-forms printers are able to print on paper up to 20 inches wide or more.

A production printing system typically includes a localized print controller that controls the overall operation of the printing system, and one or more print engines (sometimes also referred to as an “imaging engine” or “marking engine”). The print engines include a printhead controller and printhead arrays. An individual printhead includes multiple tiny nozzles (e.g., 360 nozzles per printhead depending on resolution) that are operable to discharge ink as controlled by the printhead controller. The printhead array is formed from multiple printheads that are spaced in series along a particular width, such as 20 inches.

When in operation, the printable medium is passed underneath the printhead arrays while the nozzles of the printheads discharge ink at particular intervals to form pixels on the medium. Some of the media used in inkjet printers is better suited to absorb the ink, while others are not. Thus, printing systems may be implemented with a radiant dryer unit that is able to dry the ink on the medium after the print engine discharges ink on the medium. A typical dryer unit includes an array of light bulbs that emit light and heat to dry the ink onto the medium.

### SUMMARY

Embodiments described herein provide a reflector element for a radiant dryer unit. A radiant dryer unit includes a light source, such as an array of light bulbs, and a reflector element having a reflective surface that faces toward the light source. The medium from the printer is passed between the light source and the reflector element. The light source emits light waves toward the printable medium to assist in drying ink on the medium. The reflector element reflects light waves, which pass through or pass by the medium, back towards the medium to improve the drying process of the ink. The embodiments described herein provide an improved reflector element.

In one embodiment, the reflector element includes a plurality of modular sections. Each modular section includes a base portion having a reflective surface, and includes legs that protrude from an opposing surface of the base portion. The modular sections are affixed to one another so that the reflective surfaces of the modular sections form an aggregate reflective surface that faces toward a light source of a radiant dryer unit.

Thus, the reflector element is formed from modular sections that are fastened together in a row to form an aggregate reflective surface. Prior reflectors typically used solid sheets of material for the reflective surface. However, these solid sheets were susceptible to warping due to the high temperatures often reached within the dryer unit. The modular structure of the reflector element described herein is stronger than a solid sheet so that it will not warp under these high temperatures. The modular structure also allows for improved heat dissipation over prior reflectors, because the legs of the modular sections form cooling fins (thermal fins) that dissipate heat more efficiently than flat surfaces because of the increased surface area that is exposed to cooling air.

In another embodiment, a leg of one modular section is directly affixed to a leg of another modular section. When attached in this manner, the modular sections are connected so that the reflective surfaces of the sections form an aggregate reflective surface that is substantially flat or curved (concave or convex). Thus, the modular sections are fastened to one another by the legs, which are on the opposite surface as the reflective surface. The legs of each modular section thus serve multiple purposes. The legs act as connection points where two modular sections can be fastened to one another. Also, the legs are able to dissipate heat from the aggregate reflective surface by acting as fins of a heat sink. Thus, the modular structure of the reflector element is able to effectively dissipate heat on the aggregate reflective surface.

In another embodiment, the legs of each modular section protrude from the opposing surface at an angle, and the legs are substantially parallel to one another. The angle of the legs in relation to the opposing surface may be in the range of 30 degrees and 90 degrees.

The invention may include other exemplary embodiments described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a printing system in an exemplary embodiment.

FIG. 2 illustrates a dryer unit in an exemplary embodiment.

FIG. 3 is an isometric view of a reflector element in an exemplary embodiment.

FIG. 4 illustrates a modular section in an exemplary embodiment.

FIG. 5 shows a dryer unit in another exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

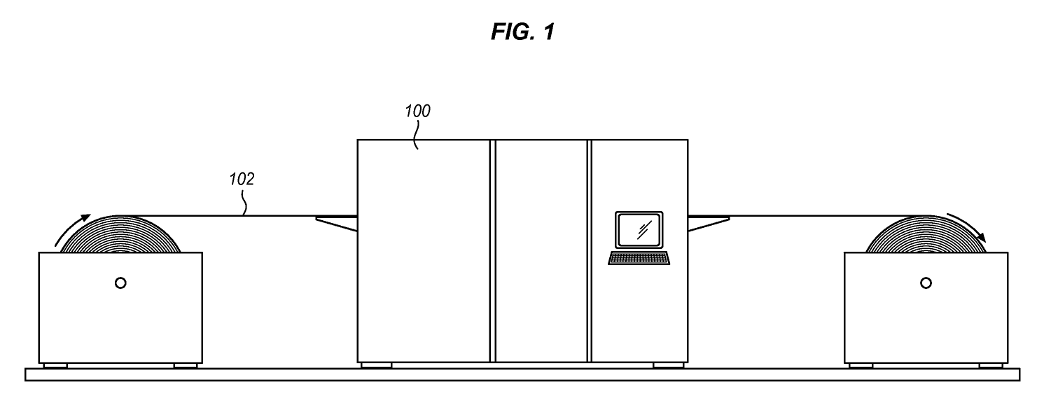

FIG. 1 illustrates a printing system 100 in an exemplary embodiment. Printing system 100 comprises any continuous-forms printer used to mark a printable medium 102. In this embodiment, printing system 100 comprises a production printing system that uses a recording liquid, such as ink, to mark printable medium 102. Although not specifically shown in FIG. 1, printing system 100 includes a print controller, and one or more print engines. The print engines include a print head controller and arrays of print heads that discharge the recording liquid onto medium 102 as it passes under the print heads. After a print engine discharges the recording liquid onto medium 102, printing system 100 may include a radiant dryer unit that assists in drying or adhering the recording liquid on medium 102.

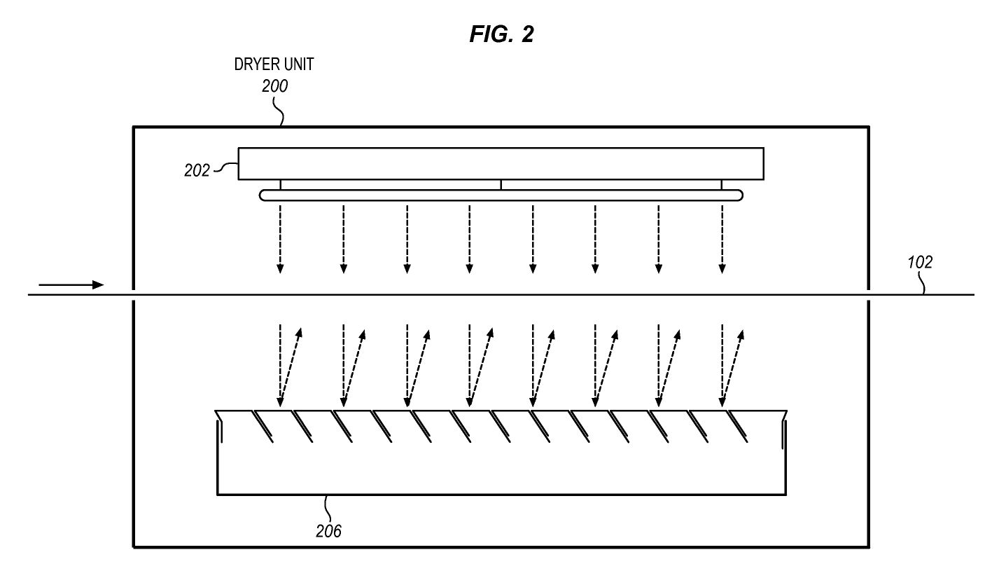

FIG. 2 illustrates a dryer unit 200 in an exemplary embodiment. Dryer unit 200 is installed in printing system 100 after the print heads in order to dry the recording liquid that is printed on medium 102. Dryer unit 200 includes a light source 202, such as an array of lamps or light bulbs, that emits light (e.g., Infra-Red light). The light waves are illustrated as dotted arrows in FIG. 2. The radiant energy in the light waves help to dry ink on medium 102 as the medium 102 passes through dryer unit 200. Some of the light waves may pass through or pass by medium 102 during the drying process. Thus, dryer unit 200 also includes a reflector element 206 that is opposite light source 202 (i.e., on the other side of medium 102). Reflector element 206 acts to reflect the light waves that pass through or around medium 102 back towards medium 102 to assist in the drying process.

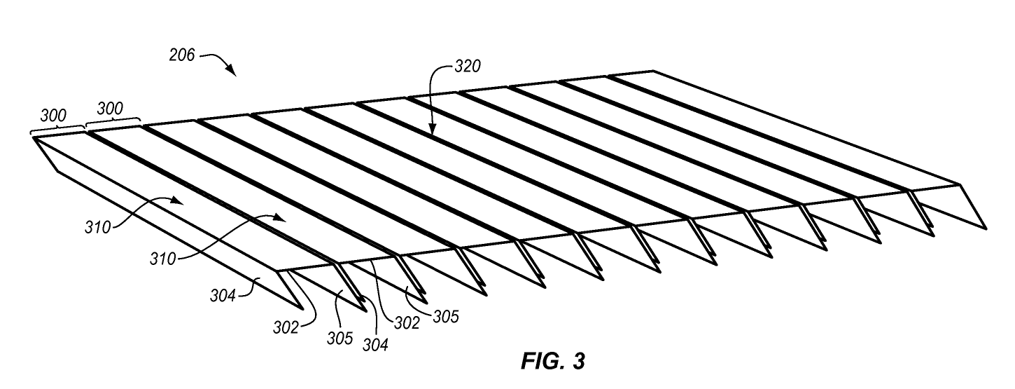

FIG. 3 is an isometric view of reflector element 206 in an exemplary embodiment. In this embodiment, reflector element 206 is comprised of a plurality of modular sections 300. Each modular section 300 includes a base portion 302 having reflective surface 310. Reflective surface 310 may be substantially flat as illustrated in FIG. 3, or may be curved. In FIG. 3, base portion 302 is the top-most member of each modular section 300, where the reflective surface 310 faces upward. Each modular section 300 also includes legs 304-305 that protrude or project from an opposing surface of base portion 302. The opposing surface faces downward in FIG. 3, and legs 304-305 extend downward in FIG. 3 from the opposing surface. Legs 304-305 connect to base portion 302 along the length of its sides so that the shape of each modular section is substantially U-shaped.

Modular sections 300 are affixed to one another so that reflective surfaces 310 of modular sections 300 form an aggregate reflective surface 320 that faces toward light source 202 (see FIG. 2) of dryer unit 200. The aggregate reflective surface 320 of reflector element 206 is used to reflect the light waves that pass through or around printable medium 102 back towards medium 102 to assist in the drying process.

To form the reflector element 206, a leg 305 of one modular section 300 is affixed or fastened to a leg 304 of another modular section 300 as shown in FIG. 3. The legs 304-305 may be bolted, riveted, or otherwise fastened (e.g., welded), so that the modular sections 300 form a structure having the aggregate reflective surface 320. The legs 304-305 of each modular section 300 thus serve multiple purposes. Legs 304-305 acts as connection points where two modular sections 300 can be affixed to one another. Each leg of a single module may be of a different length to improve the ability to construct the whole assembly. Using the legs 304-305 as connection points is advantageous because the fasteners are used on non-reflective surfaces instead of reflective surfaces. Also, legs 304-305 are able to dissipate heat from the aggregate reflective surface 320. When in operation, aggregate reflective surface 320 of reflector element 206 may reach high temperatures. Because legs 304-305 of each modular section 300 are connected to aggregate reflective surface 320, thermal energy from aggregate reflective surface 320 is able to dissipate through the surface area of legs 304-305. Legs 304-305 thus act as fins of a heat sink to transfer thermal energy from aggregate reflective surface 320 to the air (or possibly another fluid such as water) around legs 304-305. The transfer of thermal energy may be improved using one or more fans in dryer unit 200 to blow air between legs 304-305 of the modular sections 300.

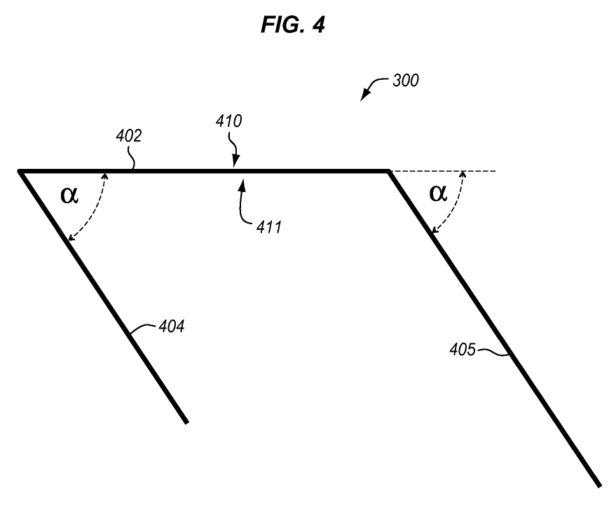

FIG. 4 illustrates a modular section 300 in an exemplary embodiment. In this embodiment, modular section 300 comprises a U-shaped channel. Like FIG. 3, the U-shaped channel includes a base portion 402 and legs 404-405 (also referred to as fins or extensions). Base portion 402 has a reflective surface 410 that will face toward a light source. Legs 404-405 protrude or extend from an opposing surface 411 of base portion 402. In this embodiment, legs 404-405 protrude from surface 411 at an angle α. Each leg 404-405 protrudes from surface 411 at about the same angle so that legs 404-405 are substantially parallel to one another. The angle of legs 404-405 in relation to surface 411 may be in the range of 30 degrees and 90 degrees.

The U-shaped channel in FIG. 4 may be made from a single piece of material that is bent into the shape shown in FIG. 4. By bending a single piece of material, there is material continuity between base portion 402 and legs 404-405. The material continuity allows for more efficient heat transfer from reflective surface 410 to legs 404-405. This means that a thermal paste or surface treatment is not needed.

The U-shaped channel shown in FIG. 4 is just one embodiment of a modular section. In other embodiments, legs 404-405 may be substantially perpendicular to surface 411 instead of at an angle. In other embodiments, legs 404-405 may be of the same length. The U-shaped channel may also include one or more fins attached to surface 411 between legs 404-405 in order to further dissipate heat from reflective surface 410.

The modular structure of reflector element 206 is a more effective reflector design than prior reflectors used in radiant dryer units. Prior reflectors used solid sheets of material for the reflective surface. Because of the high temperatures often reached within the dryer unit, the prior reflectors were prone to material deformation. The modular structure of reflector element 206 is stronger than a solid sheet so that it will not warp under these high temperatures. The modular structure also allows for improved heat dissipation over prior reflectors, and is more cost effective in manufacturing.

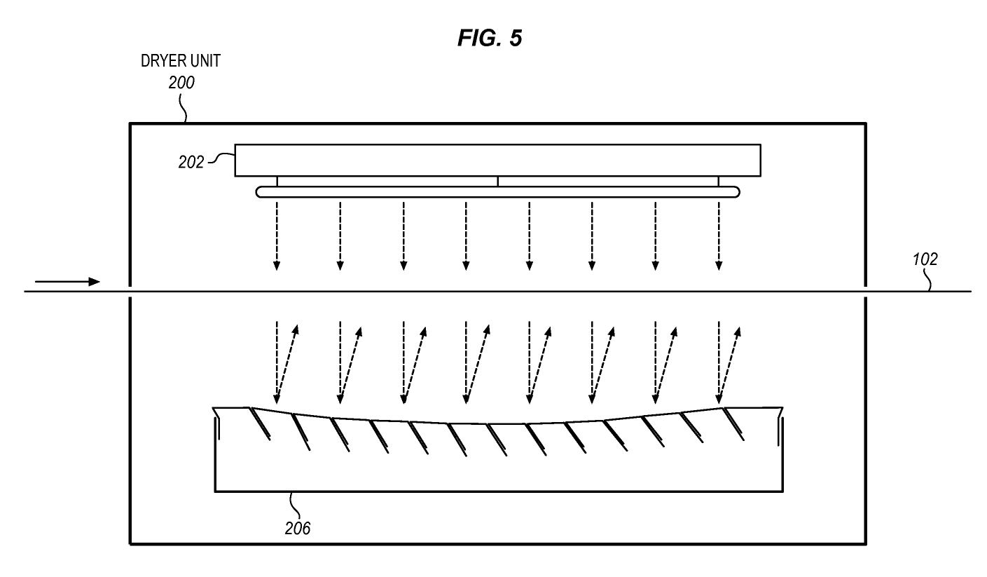

The reflector element 206 shown in FIG. 2 has a substantially flat aggregate reflective surface that faces toward light source 202. The aggregate reflective surface may also be curved, such as concave or convex. FIG. 5 shows a dryer unit in another exemplary embodiment. In this embodiment, the aggregate reflective surface is concave, and reflects the light waves that pass through or around printable medium 102 back towards medium 102 to assist in the drying process.

In another embodiment, one or more of the modular sections 310 may include an absorbing surface rather than a reflective surface. The absorbing surface absorbs the light waves that pass through or pass by printable medium 102 during the drying process. A modular section having an absorbing surface can then dissipate heat created by the light waves through its legs.

Although specific embodiments were described herein, the scope of the invention is not limited to those specific embodiments. The scope of the invention is defined by the following claims and any equivalents thereof.

We claim:

1. A reflector element for a radiant dryer unit of a printer, the reflector element comprising:
a plurality of modular sections each including a base portion having a reflective surface, and including legs that protrude from an opposing surface of the base portion;
wherein the modular sections are affixed to one another so that the reflective surfaces of the modular sections form an aggregate reflective surface that faces toward a light source in the radiant dryer unit of the printer.

2. The reflector element of claim 1 wherein:
the legs of each modular section protrude from the opposing surface at an angle and are substantially parallel to one another.

3. The reflector element of claim 2 wherein:
the angle of the legs in relation to the opposing surface is in the range of 30 degrees and 90 degrees.

4. The reflector element of claim 1 wherein:
a leg of one modular section is fastened to a leg of another modular section to connect the modular sections so that the reflective surfaces of the modular sections form the aggregate reflective surface.

5. The reflector element of claim 1 wherein the modular sections each comprise a piece of material bent into a U-shaped channel.

6. A dryer unit for a printer, the dryer unit comprising:
a light source operable to emit light waves; and
a reflector element installed opposite the light source such that a printable medium is able to pass between the light source and the reflector element;
the reflector element comprising:
a plurality of modular sections each including a base portion having a reflective surface, and including legs that protrude from an opposing surface of the base portion;
wherein the modular sections are affixed to one another so that the reflective surfaces of the modular sections form an aggregate reflective surface that faces toward the light source and reflects the light waves back toward the printable medium.

7. The dryer unit of claim 6 wherein:
the legs of each modular section protrude from the opposing surface at an angle and are substantially parallel to one another.

8. The dryer unit of claim 7 wherein:
the angle of the legs in relation to the opposing surface is in the range of 30 degrees and 90 degrees.

9. The dryer unit of claim 6 wherein:
a leg of one modular section is fastened to a leg of another modular section to connect the modular sections so that the reflective surfaces of the modular sections form the aggregate reflective surface.

10. The dryer unit of claim 6 wherein the modular sections each comprise a piece of material bent into a U-shaped channel.

11. The dryer unit of claim 6 further comprising:
a fan operable to blow air between the legs of the modular sections to dissipate heat on the reflective surfaces of the modular sections.

12. The dryer unit of claim 6 wherein:
the light source comprises an Infra-Red light source.

13. A printer comprising:
a print engine operable to print ink onto a printable medium; and
a dryer unit operable to receive the printable medium after the ink is printed onto the medium;
wherein the dryer unit includes a light source and a reflector element;
wherein the reflector element is comprised of a plurality of modular sections each including a base portion having a reflective surface, and including legs that protrude from an opposing surface of the base portion;
wherein the modular sections are affixed to one another so that the reflective surfaces of the modular sections form an aggregate reflective surface that faces toward the light source and reflects the light waves back toward the printable medium.

14. The printer of claim 13 wherein:
the legs of each modular section protrude from the opposing surface at an angle and are substantially parallel to one another.

15. The printer of claim 14 wherein:
the angle of the legs in relation to the opposing surface is in the range of 30 degrees and 90 degrees.

16. The printer of claim 13 wherein:
a leg of one modular section is fastened to a leg of another modular section to connect the modular sections so that the reflective surfaces of the modular sections form the aggregate reflective surface.

17. The printer of claim 13 wherein the modular sections each comprise a piece of material bent into a U-shaped channel.

18. The printer of claim 13 further comprising:
a fan operable to blow air between the legs of the modular sections to dissipate heat on the reflective surfaces of the modular sections.

19. The printer of claim 13 wherein:
the light source comprises an Infra-Red light source.
